(19) United States
(12) Patent Application Publication
(10) Pub. No.: US 2026/0343046 A1
(43) Pub. Date: Oct. 29, 2026

(54) ELECTRONIC DEVICE AND OPERATION METHOD THEREOF

(71) Applicant: SAMSUNG ELECTRONICS CO., LTD., Suwon-si (KR)

(72) Inventors: Taehwa LEE, Suwon-si (KR); Minsang KIM, Suwon-si (KR)

(73) Assignee: SAMSUNG ELECTRONICS CO., LTD., Suwon-si (KR)

(21) Appl. No.: 19/698,413

(22) Filed: Jun. 4, 2026

Related U.S. Application Data
(63) Continuation of application No. PCT/KR2024/016426, filed on Oct. 25, 2024.

(30) Foreign Application Priority Data
Dec. 4, 2023 (KR) 10-2023-0173447

(51) Int. Cl. H04N 21/4363; H04N 21/4402; H04N 21/442

(52) U.S. Cl. CPC H04N 21/43635; H04N 21/43637; H04N 21/4402; H04N 21/442

(57) ABSTRACT

A first electronic device according to an embodiment includes a transceiver for receiving an HDMI signal from a source device and transmitting the HDMI signal to a second electronic device; a memory for storing one or more instructions; and at least one processor for executing the one or more instructions. By executing the one or more instructions, the at least one processor may control the transceiver to transmit the HDMI signal received from the source device to the second electronic device through a plurality of signal lanes; and on the basis of receiving a lane change command from the second electronic device, control the transceiver to transmit the HDMI signal to the second electronic device through changed signal lanes.

### CROSS-REFERENCE TO RELATED APPLICATIONS

This application is a Continuation Application of International Application No. PCT/KR 2024/016426 filed on Oct. 25, 2024, which claims priority to Korean Patent Application No. 10-2023-013447, filed on Dec. 4, 2023, at the Korean Ministry of Intellectual Property, the disclosures of which are incorporated herein in their entireties by reference.

### BACKGROUND

### 1. Field

Various embodiments relate to a first electronic device configured to transmit, to a second electronic device, a high-definition multi-media interface (HDMI) signal received from a source device, and an operating method of the first electronic device, the second electronic device configured to receive the HDMI signal from the first electronic device, and an operating method of the second electronic device.

### 2. Background of the Related Art

High-definition multimedia interface (HDMI) is the standard for connecting devices supporting the HDMI by using a single cable to mainly transmit high-resolution video and multi-channel audio data.

Recently, as content having ultra high-definition (HD) resolution, which is beyond full HD resolution, increases, devices having HDMI ports supporting HDMI 2.1 have been steadily distributed. Accordingly, consumers can enjoy content having high resolution and high scan rates. In the HDMI 2.1 version, a fixed rate link (RFL) output format may be used.

### SUMMARY

A first electronic device according to an embodiment may include a transceiver configured to receive a high-definition multi-media interface (HDMI) signal from a source device and transmit the HDMI signal to a second electronic device.

The first electronic device according to an embodiment may include memory storing one or more instructions and at least one processor configured to execute the one or more instructions.

The at least one processor may be configured to execute the one or more instructions to control the transceiver to transmit the HDMI signal received from the source device to the second electronic device through a plurality of signal lanes.

The at least one processor may be configured to execute the one or more instructions to control the transceiver to transmit the HDMI signal to the second electronic device through a changed signal lane, based on receiving a lane change command from the second electronic device.

A second electronic device according to an embodiment may include a transceiver configured to receive an HDMI signal from a first electronic device.

The second electronic device according to an embodiment may include a display, memory storing one or more instructions, and at least one processor configured to execute the one or more instructions.

The at least one processor may be configured to execute the one or more instructions to identify an abnormal from among a plurality of signal lanes through which the HDMI signal is received, or travels.

The at least one processor may be configured to execute the one or more instructions to control the transceiver to transmit, to the first electronic device, a lane change command requesting a change of the abnormal signal lane.

The at least one processor may be configured to execute the one or more instructions to control the transceiver to receive the HDMI signal through a changed signal lane.

The at least one processor may be configured to execute the one or more instructions to control the display to display content corresponding to the received HDMI signal.

An operating method of a first electronic device according to an embodiment may include receiving an HDMI signal from a source device.

The operating method of the first electronic device according to an embodiment may include transmitting the HDMI signal received from the source device to a second electronic device through a plurality of signal lanes.

The operating method of the first electronic device according to an embodiment may include transmitting the HDMI signal to the second electronic device through a changed signal lane, based on receiving a lane change command from the second electronic device.

An operating method of a second electronic device according to an embodiment may include receiving an HDMI signal from a first electronic device.

The operating method of the second electronic device according to an embodiment may include identifying an abnormal signal lane from among a plurality of signal lanes through which the HDMI signal is received, or travels.

The operating method of the second electronic device according to an embodiment may include transmitting a lane change command requesting a change of the abnormal signal lane to the first electronic device.

The operating method of the second electronic device according to an embodiment may include receiving the HDMI signal through a changed signal lane.

The operating method of the second electronic device according to an embodiment may include displaying content corresponding to the received HDMI signal.

One or more non-transitory computer readable media can store instructions to perform one or more of the operating methods of the first device, or the operating method of the second device.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a source device and a sink device according to an embodiment;

FIG. 2 is a table showing transmission bandwidths per lane and the numbers of transmission lanes corresponding to transmission bandwidths that can be supported in high-definition multi-media interface (HDMI) 2.1;

FIG. 3 is a diagram illustrating a connection structure of a source device and a sink device, according to an embodiment;

FIG. 4 is a flowchart of an operating method of an HDMI repeater, according to an embodiment;

FIG. 5 is a flowchart of an operating method of an HDMI sink device, according to an embodiment;

FIG. 6 is a flowchart of an operating method of a system configured to transmit and receive an HDMI signal, according to an embodiment;

FIG. 7 is a block diagram of components of an HDMI repeater according to an embodiment;

FIG. 8 is a block diagram of components of an HDMI sink device according to an embodiment; and

FIG. 9 is a block diagram of components of an HDMI sink device according to an embodiment.

### DETAILED DESCRIPTION

The terms used in this specification will be briefly described and then the present disclosure will be described in detail.

The terms used in the present disclosure are general terms as possible that have been widely used nowadays in consideration of the functions in the disclosure, which, however, may be changed according to an intention of a technician in the art, a precedent, the advent of new technologies, or the like. Also, in particular cases, there may be terms arbitrarily selected by an applicant, and in this case, the meanings of the terms will be described in detail in the corresponding parts of the description of the disclosure. Therefore, the terms used in the present disclosure should be defined based on the meanings of the terms and the content throughout the disclosure, rather than being defined simply based on the titles of the terms.

Throughout the specification, when a part “includes” an element, the part may further include other elements, rather than excluding the other elements, unless there is a particular description contrary thereto. Also, terms such as “unit,” “module,” etc., described in the specification indicate a unit that processes at least one function or operation, and the unit may be embodied in a hardware manner, a software manner, or a combination of the hardware manner and the software manner.

Hereinafter, embodiments will be described in detail with reference to the accompanying drawings, so that the embodiments may be easily implemented by one of ordinary skill in the art of the present disclosure. However, the present disclosure may have different forms and should not be construed as being limited to the embodiments described herein. Also, in the drawings, parts not related to descriptions are omitted for the clear description of the present disclosure, and throughout the specification, like reference numerals are used for like elements.

According to an embodiment in this specification, the term “user” may denote a person controlling a system, a function, or an operation and may include a manufacturer, a manager, or an installation technician.

Also, according to an embodiment in this specification, an “image” or a “picture” may indicate a still image, a motion image including a plurality of consecutive still images (or frames), or video.

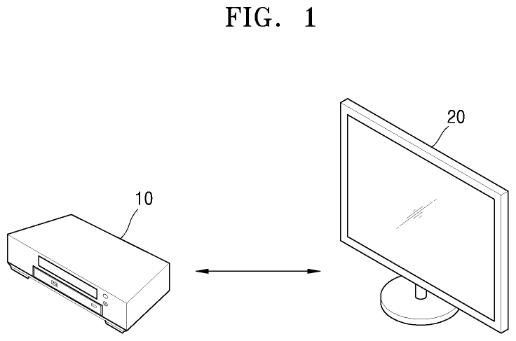

FIG. 1 is a diagram illustrating a source device and a sink device according to an embodiment.

Referring to FIG. 1, a sink device 20 according to an embodiment may be connected to a source device 10 through wired or wireless communication.

The source device 10 according to an embodiment may provide content such as video or audio to the sink device 20. For example, the source device 10 may include a video game console. However, it is not limited thereto, and the source device 10 may include various types of electronic devices that are capable of providing content to the sink device 20, such as a set-top box, a digital versatile disc (DVD) player, a Blu-ray disc, a personal computer (PC), and a game machine. The source device 10 may be a device that provides content and is referred to as a source device, but in addition to this, may be referred to as a host device, a content providing device, an electronic device, a storage device, a computing device, a server device, a server, etc.

The sink device 20 according to an embodiment may include an electronic device that processes and reproduces content received from the source device 10. For example, the sink device 20 may include an electronic device configured to output or display content received from the source device 10. The sink device 20 may include various types of electronic devices, which may receive and output content. For example, the sink device 20 may include a television (TV), a desktop, a notebook computer, a cellular phone, a tablet PC, a digital camera, a camcorder, a laptop computer, a desktop, an electronic book terminal, a digital broadcasting terminal, a personal digital assistant (PDA), a portable multimedia player (PMP), a navigation device, a game player, a music player, a video player, a medical apparatus, a home appliance product, a wearable device, etc. The sink device 20 may receive and display content and may be referred to as a content receiving device, a display device, an electronic device, or a computing device.

The source device 10 and the sink device 20 may transmit and receive the content through wired communication. For example, the source device 10 and the sink device 20 may be connected to each other through a cable, and each of the source device 10 and the sink device 20 may include one or more ports for cable connection. The one or more ports may include, for example, a high-definition multi-media interface (HDMI) port, a display port, or a digital input/output interface such as a type-C.

Alternatively, the source device 10 and the sink device 20 may transmit and receive the content through wireless communication. For example, the source device 10 and the sink device 20 may include at least one communication module for performing communication according to the communication standards, such as Bluetooth, WiFi, Bluetooth low energy (BLE), near-field communication (NFC)/radio-frequency identification (RFID), WiFi direct, ultra wideband (UWB), Zigbee, the Internet, and the third generation (3G), fourth generation (4G), fifth generation (5G), and/or sixth generation (6G).

The source device 10 and the sink device 20 according to an embodiment may be connected to each other through an HDMI cable for performing wired HDMI communication. For example, each of the source device 10 and the sink device 20 may include the HDMI port and may perform communication through the HDMI cable connected to the corresponding port.

The HDMI communication standards according to an embodiment may be HDMI 2.1 or higher. HDMI 2.1 or higher may support both of a transition minimized differential signaling (hereinafter, referred to as TMDS) transmission method and a fixed rate link (hereinafter, referred to as FRL) transmission method.

The HDMI 2.1 may facilitate the transmission of a content signal having a higher resolution as compared to the case of previous versions, for example, a content signal at a resolution level of 8K. When a display included in the sink device 20 according to an embodiment wants to display an image of the level of 8K, it is necessary that the source device 10 as well as the sink device 20 may support HDMI 2.1

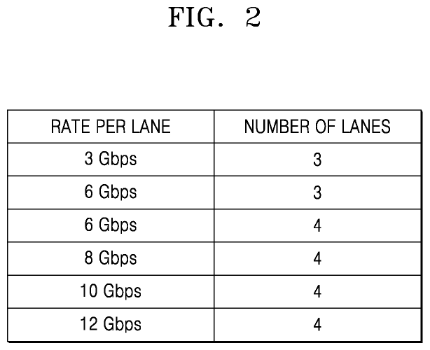

The HDMI 2.1 may have the similar basic structure to its previous versions, but the HDMI 2.1 has several differences from the previous versions. The HDMI 2.1 may provide the transmission bandwidth of 48 Gbps, which is 2.5 times or higher than the transmission bandwidth of 18 Gbps of HDMI 2.0. The transmission bandwidth of the HDMI 2.0 is described in detail with reference to FIG. 2.

FIG. 2 is a table showing transmission bandwidths per lane and the numbers of transmission lanes corresponding to transmission bandwidths that can be supported in HDMI 2.1.

The HDMI 2.1 may support an FRL transmission method. When the FRL transmission method is used, a high bandwidth signal may be transmitted.

Referring to FIG. 2, when three lanes are driven at 3 Gbps per lane, HDMI 2.1 may provide a transmission bandwidth of 9 Gbps.

Also, when three lanes are driven at 6 Gbps per lane, the HDMI 2.1 may provide a transmission bandwidth of 18 Gbps, and when four lanes are driven at 6 Gbps per lane, the HDMI 2.1 may provide a transmission bandwidth of 24 Gbps.

Also, when four lanes are driven at 8 Gbps per lane, the HDMI 2.1 may provide a transmission bandwidth of 32 Gbps, when four lanes are driven at 10 Gbps per lane, the HDMI 2.1 may provide a transmission bandwidth of 40 Gbps, and when four lanes are driven at 12 Gbps per lane, the HDMI 2.1 may provide a transmission bandwidth of 48 Gbps.

The HDMI 2.1 may also transmit high dynamic range (HDR) content encoded in 10-bit colors at 4K and up to 144 Hz, and may support non-compression transmission thereof at 8K and up to 30 Hz. While a pre-HDMI 2.1 version may transmit a content signal through three lanes, the HDMI 2.1 may transmit a content signal through four lanes. Thus, a data transmission rate according to the HDMI 2.1 may be much higher than the pre-HDMI 2.1 version.

HDMI cables and connectors may include four differential pairs including four lanes LANE 0, LANE 1, LANE 2, and LANE 3 that are configured to transmit data. These lanes may be used to transmit video data, audio data, and auxiliary data. The term “lane” in this specification may be referred to as a signal lane or a channel.

According to an embodiment, the HDMI 2.1 may transmit data by using the total of four data lanes by using a clock lane configured to transmit a clock signal previously as a data lane.

For example, in the pre-HDMI 2.1 version, three signal lanes Lane 0, Lane 1, and Lane 2 from among the four signal lanes Lane 0, Lane 1, Lane 2, and Lane 3 may be used as data channels, and one signal lane (for example, Lane 3) may be used as a clock channel.

The HDMI 2.1 may transmit content data through the four signal lanes Lane 0, Lane 1, Lane 2, and Lane 3 and may have not an additional clock channel for transmitting a clock signal. In the HDMI 2.1, a clock signal may not be separately transmitted from data, but may be embedded in the data. That is, the signal lane Lane 3 used as the clock channel in the pre-HDMI 2.1 version may be used as a data channel in the HDMI 2.1.

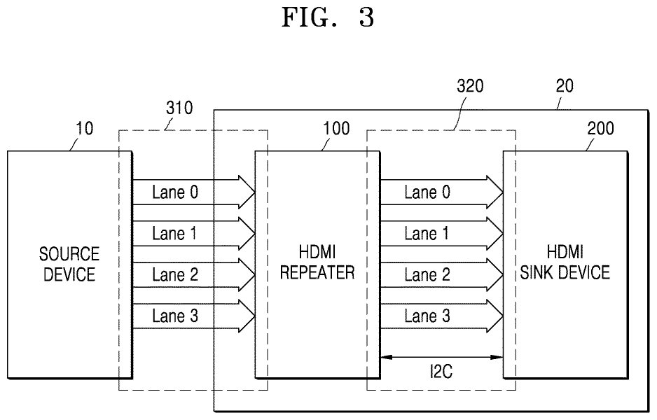

FIG. 3 is a diagram illustrating a connection structure of a source device and a sink device, according to an embodiment.

Referring to FIG. 3, the sink device 20 according to an embodiment may include an HDMI repeater 100 and an HDMI sink device 200. FIG. 2 illustrates that the HDMI repeater 100 may be included in the sink device 20. However, according to an embodiment, the HDMI repeater 100 may be provided as a separate device from the HDMI sink device 200.

The HDMI repeater 100 may transmit content received from the source device 10 to another repeater or the HDMI sink device 200 through HDMI communication. For example, the HDMI repeater 100 may include an audio and video (AV) receiver, a sound bar, etc. However, it is not limited thereto.

The source device 10 and the HDMI repeater 100 according to an embodiment may be connected to each other through an HDMI cable. For example, each of the source device 10 and the HDMI repeater 100 may include an HDMI port, and may perform HDMI communication through the HDMI cable connected to the corresponding port. The HDMI repeater 100 may receive the content from the source device 10 through the HDMI communication. The source device 10 may transmit content data to the HDMI repeater 100 through four signal lanes 310 according to an FRL communication method.

Each of the HDMI repeater 100 and the HDMI sink device 200 according to an embodiment may also include an HDMI port, and may perform communication through an HDMI cable connected to the corresponding port. For example, the HDMI repeater 100 may transmit the content received from the source device 10 to the HDMI sink device 200 through the HDMI communication. The HDMI repeater 100 may transmit content data to the HDMI sink device 200 through four signal lanes 320 according to the FRL communication method.

The HDMI repeater 100 and the HDMI sink device 200 according to an embodiment may perform communication according to other communication methods than the HDMI communication. For example, the HDMI repeater 100 and the HDMI sink device 200 may perform inter-integrated circuit (I2C) communication. The HDMI repeater 100 and the HDMI sink device 200 may receive data or information by using the I2C communication. However, it is not limited thereto.

When the HDMI repeater 100 transmits an HDMI signal (the content data) to the HDMI sink device 200 according to the FRL transmission method, an abnormality may be generated in some signal lanes from among signal lanes through which the HDMI signal is transmitted. In this case, the HDMI sink device 200 may not be able to normally receive the HDMI signal.

Thus, the HDMI sink device 200 according to an embodiment may detect an abnormality of a signal lane through which the HDMI signal is received. The HDMI sink device 200 may transmit, to the HDMI repeater 100, a lane change command to change the signal lane detected to have an abnormality to another signal lane to transmit the HDMI signal.

When the HDMI repeater 100 according to an embodiment receives the lane change command from the HDMI sink device 200, the HDMI repeater 100 may change the signal lane through which the HDMI signal is transmitted and transmit the HDMI signal through the changed signal lane.

With reference to the drawings hereinafter, operations of the HDMI repeater 100 and the HDMI sink device 200 are described in detail.

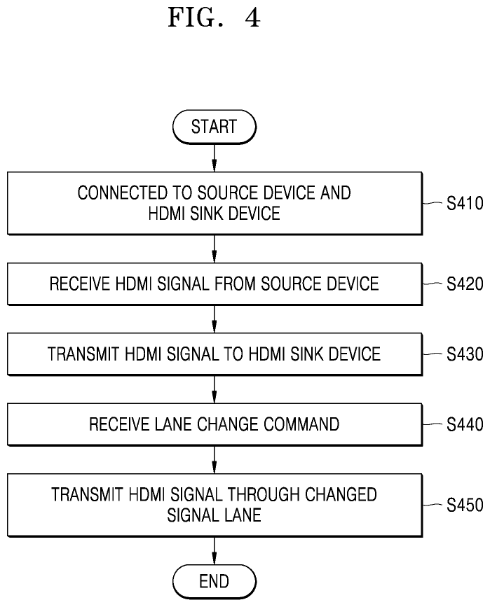

FIG. 4 is a flowchart of an operating method of an HDMI repeater, according to an embodiment.

Referring to FIG. 4, the HDMI repeater 100 according to an embodiment may be connected to the source device 10 and the HDMI sink device 200 in operation S410.

For example, the HDMI repeater 100 may be connected to the source device 10 through an HDMI cable for performing HDMI communication. Also, the HDMI repeater 100 may be connected to the HDMI sink device 200 through the HDMI cable for performing HDMI communication.

The HDMI repeater 100 according to an embodiment may receive an HDMI signal from the source device 10 in operation S420.

The source device 10 may transmit the HDMI signal to the HDMI repeater 100 through the HDMI communication. The source device 10 and the HDMI repeater 100 may support HDMI 2.1 or a higher version. The source device 10 may transmit the HDMI signal to the HDMI repeater 100 according to an FRL transmission method. The source device 10 may transmit the HDMI signal to the HDMI repeater 100 by using four signal lanes Lane 0, Lane 1, Lane 2, and Lane 3.

The HDMI repeater 100 according to an embodiment may transmit the HDMI signal to the HDMI sink device 200 in operation S430.

The HDMI repeater 100 may transmit the HDMI signal received from the source device 10 to the HDMI sink device 200 through the HDMI communication. The HDMI repeater 100 and the HDMI sink device 200 may support HDMI 2.1 or a higher version. The HDMI repeater 100 may transmit the HDMI signal to the HDMI sink device 200 according to the FRL transmission method. The HDMI repeater 100 may transmit the HDMI signal to the HDMI sink device 200 by using four signal lanes Lane 0, Lane 1, Lane 2, and Lane 3.

The HDMI repeater 100 according to an embodiment may receive a lane change command from the HDMI sink device 200 in operation S440.

For example, while the HDMI repeater 100 transmits the HDMI signal to the HDMI sink device 200, the HDMI repeater 100 may receive the lane change command from the HDMI sink device 200. The HDMI repeater 100 may receive the lane change command through other communication methods than the HDMI communication. For example, the HDMI repeater 100 may receive the lane change command through an I2C communication method. However, it is not limited thereto.

The HDMI repeater 100 according to an embodiment may transmit the HDMI signal to the HDMI sink device 200 through a changed signal lane in operation S450.

When the HDMI repeater 100 receives the lane change command from the HDMI sink device 200, the HDMI repeater 100 may change a signal lane through which the HDMI signal is transmitted, in response to the corresponding command. For example, while the HDMI repeater 100 transmits the HDMI signal to the HDMI sink device 200 through Lane 0, Lane 1, and Lane 2, the HDMI repeater 100 may receive a command to change Lane 2 from the HDMI sink device 200. The HDMI repeater 100 may change a transmission lane from Lane 2 to Lane 3, in response to the command received from the HDMI sink device 200. The HDMI repeater 100 may transmit the HDMI signal to the HDMI sink device 200 through Lane 0, Lane 1, and Lane 3.

Alternatively, when the HDMI repeater 100 receives the command to change Lane 2 from the HDMI sink device 200, while the HDMI repeater 100 transmits the HDMI signal to the HDMI sink device 200 through Lane 0, Lane 1, Lane 2, and Lane 3, the HDMI repeater 100 may not use Lane 2 as the transmission lane in response to the received command. The HDMI repeater 100 may encode the HDMI signal and transmit the encoded HDMI signal to the HDMI sink device 200 through Lane 0, Lane 1, and Lane 3. However, it is not limited thereto.

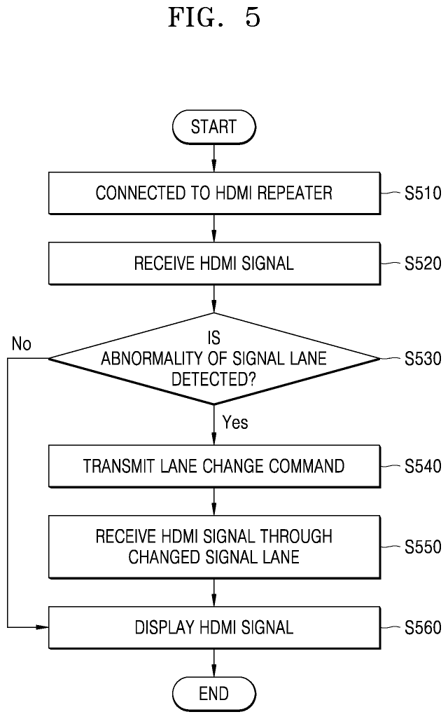

FIG. 5 is a flowchart of an operating method of an HDMI sink device, according to an embodiment.

Referring to FIG. 5, the HDMI sink device 200 according to an embodiment may be connected to the HDMI repeater 100 in operation S510.

For example, the HDMI sink device 200 may be connected to the HDMI repeater 100 through an HDMI cable for performing HDMI communication.

The HDMI sink device 200 according to an embodiment may receive an HDMI signal from the HDMI repeater 100 in operation S520.

The HDMI repeater 100 according to an embodiment may transmit an HDMI signal received from the source device 10 to the HDMI sink device 200 through the HDMI communication. The HDMI repeater 100 and the HDMI sink device 200 may support HDMI 2.1 or a higher version. The HDMI repeater 100 may transmit the HDMI signal to the HDMI sink device 200 according to an FRL transmission method. For example, the HDMI repeater 100 may transmit the HDMI signal to the HDMI sink device 200 by using four signal lanes Lane 0, Lane 1, Lane 2, and Lane 3.

The HDMI sink device 200 according to an embodiment may detect an abnormality of signal lanes through which the HDMI signal is received, in operation S530.

The HDMI sink device 200 according to an embodiment may obtain information indicating a channel state, information indicating an occurrence of an abnormality, etc. corresponding to each of the signal lanes through which the HDMI signal is received.

The HDMI sink device 200 may include a register storing information corresponding to each of the signal lanes. For example, the register may include a status and control data channel (SCDC) register. However, it is not limited thereto.

The register may include the information indicating the channel state corresponding to each of the signal lanes. Here, the information indicating the channel state may include information indicating whether or not a content signal (a video or audio signal) is normally transmitted and received through a corresponding channel (lane). For example, the channel state information may include a value of Chx_Lnx_Locked, wherein, when the value of Chx_Lnx_locked is “1,” it is indicated that the content signal is normally transmitted and received through a corresponding channel, and when the value of Chx_Lnx_locked is “0,” it is indicated that the content signal is not normally transmitted and received through the corresponding channel. However, it is not limited thereto.

When the value of Chx_Lnx_Locked of the register is “0,” the HDMI sink device 200 may determine that there is an abnormality in the corresponding channel (lane). However, it is not limited thereto.

Also, the register may detect an error occurrence corresponding to each lane. For example, the register may detect an occurrence of a control error detection (CED) error, wherein the CED error may include an error generated when there is a problem during a process of transmitting or processing control data packets included in the HDMI signal received through a corresponding channel (lane). When the occurrence of the CED error is detected, the HDMI sink device 200 may determine that there is an abnormality in the corresponding channel (lane). However, it is not limited thereto.

Alternatively, the register may include a Reed-Solomon corrections counter (RSCC) value. The register may detect an error of a Reed-Solomon parity value included in the HDMI signal, and whenever the error is detected, may increase the RSCC value. When the RSCC value of the register is a preset value or higher, the HDMI sink device 200 may determine that there is an abnormality in the corresponding channel (lane). However, it is not limited thereto.

Methods used by the HDMI sink device 200 to detect whether or not there is an abnormality in the signal lanes through which the HDMI signal is received are not limited to the examples described above, and various methods may be used to determine whether or not there is an abnormality in the lanes. The HDMI sink device 200 may identify a lane in which there is an abnormality from among the lanes through which the HDMI signal is received.

The HDMI sink device 200 according to an embodiment may transmit a lane change command to the HDMI repeater 100 in operation S540.

When a lane having an abnormality is identified, the HDMI sink device 200 may transmit the lane change command requesting a change of the lane having an abnormality to the HDMI repeater 100.

The HDMI sink device 200 may transmit the lane change command through other communication methods than the HDMI communication. For example, the HDMI sink device 200 may transmit the lane change command through an I2C communication method. However, it is not limited thereto.

The lane change command may include identification information of the signal lane having an abnormality.

The HDMI sink device 200 according to an embodiment may receive the HDMI signal through a changed lane in operation S550.

The HDMI sink device 200 according to an embodiment may display an image based on the received HDMI signal in operation S560.

The HDMI sink device 200 may process the HDMI signal and display an image corresponding to video data in the processed signal.

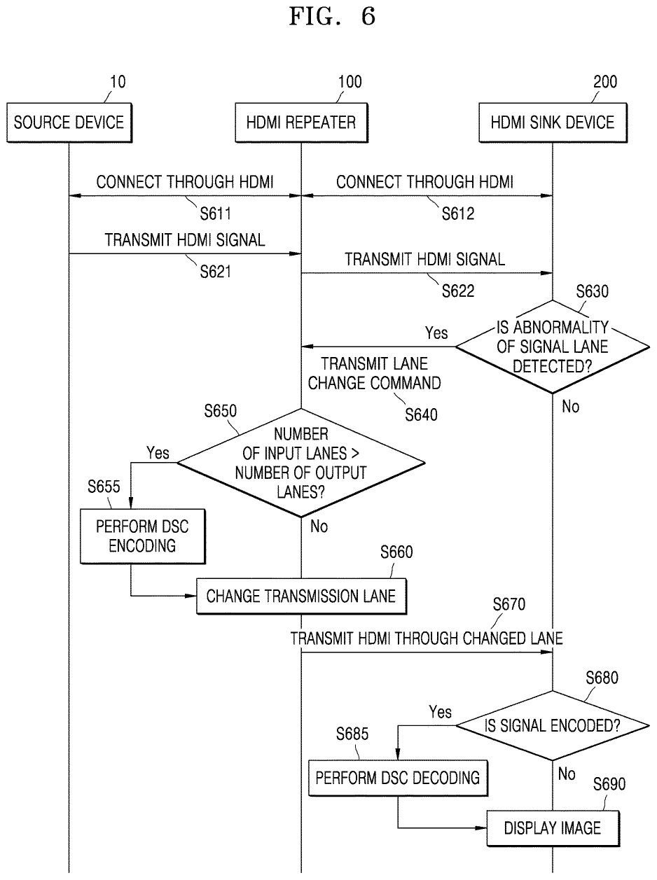

FIG. 6 is a flowchart of an operating method of a system configured to transmit and receive an HDMI signal, according to an embodiment.

Referring to FIG. 6, the source device 10 may be connected to the HDMI repeater 100 through an HDMI cable for performing HDMI communication in operation S611. Also, the HDMI repeater 100 may be connected to the HDMI sink device 200 through an HDMI cable for performing HDMI communication in operation S612.

The source device 10 according to an embodiment may transmit an HDMI signal to the HDMI repeater 100 through the HDMI communication in operation S621. The source device 10 and the HDMI repeater 100 may support HDMI 2.1 or a higher version. The source device 10 may transmit the HDMI signal to the HDMI repeater 100 according to an FRL transmission method.

The HDMI repeater 100 according to an embodiment may transmit the HDMI signal received from the source device 10 to the HDMI sink device 200 in operation S622. The HDMI sink device 200 may also support the HDMI 2.1 or a higher version, and the HDMI repeater 100 may transmit the HDMI signal to the HDMI sink device 200 according to the FRL transmission method.

The HDMI sink device 200 may detect an abnormality in signal lanes through which the HDMI signal is received, in operation S630, and when the abnormality in the signal lane is detected, the HDMI sink device 200 may transmit a lane change command to the HDMI repeater 100 in operation S640. This is described in detail with reference to operation S530 and operation S540 of FIG. 5, and thus, its detailed description is omitted.

When the HDMI repeater 100 receives the lane change command from the HDMI sink device 200, the HDMI repeater 100 may compare the number of signal lanes through which the HDMI signal is received from the source device 10 with the number of signal lanes through which the HDMI signal is to be transmitted to the HDMI sink device 200, in operation S650. When the number of signal lanes through which the HDMI signal is to be transmitted to the HDMI sink device 200 is greater than or equal to the number of signal lanes through which the HDMI signal is received, the HDMI repeater 100 may change the lane for transmitting the HDMI signal in operation S660. The HDMI repeater 100 may transmit the HDMI signal to the HDMI sink device 200 through the changed lane.

For example, the HDMI repeater 100 may receive the HDMI signal from the source device 10 through three signal lanes, and while transmitting the received HDMI signal to the HDMI sink device 200 through three signal lanes (for example, Lane 0, Lane 1, and Lane 2), the HDMI repeater 100 may receive, from the HDMI sink device 200, a command to change Lane 2.

In this case, the number of signal lanes through which the HDMI signal is received from the source device 10 is 3, and the number of signal lanes Lane 0, Lane 1, and Lane 3 for transmitting the HDMI signal to the HDMI sink device 200 is 3, and thus, the HDMI repeater 100 may change the signal lane for transmitting the HDMI signal from Lane 2 to Lane 3. The HDMI repeater 100 may transmit the HDMI signal to the HDMI sink device 200 through Lane 0, Lane 1, and Lane 3.

However, when the number of signal lanes through which the HDMI signal is to be transmitted to the HDMI sink device 200 is less than the number of signal lanes through which the HDMI signal is received, the HDMI repeater 100 may encode the HDMI signal received from the source device 10 in operation S655. For example, the HDMI repeater 100 may encode the HDMI signal received from the source device 10 according to a display stream compression (DSC) method. DSC is a compression technique for transformation/transmission of a signal having a high bandwidth compressed into a signal having a reduced bandwidth. When the DSC is used, it is possible to transmit high-resolution video and image data by compressing the high-resolution video and image data into a reduced bitrate.

The HDMI repeater 100 may transmit the encoded HDMI signal to the HDMI sink device 200 through a changed transmission lane in operation S670.

For example, the HDMI repeater 100 may receive the HDMI signal from the source device 10 through four signal lanes at 10 Gbps per lane, and while the HDMI repeater 100 transmits the received HDMI signal to the HDMI sink device 200 through four signal lanes (for example, Lane 0, Lane 1, Lane 2, and Lane 3), the HDMI repeater 100 may receive a command to change Lane 2 from the HDMI sink device 200. Here, the number of signal lanes through which the HDMI signal is received from the source device 10 is 4, and the number of signal lanes for transmitting the HDMI signal to the HDMI sink device 200, except for Lane 2, in which there is an abnormality, may be 3 (Lane 0, Lane 1, and Lane 3).

Because the number of signal lanes (for example, 3) for transmitting the HDMI signal to the HDMI sink device 200 is less than the number of signal lanes (for example, 4) receiving the HDMI signal, the HDMI repeater 100 may encode the HDMI signal received from the source device 10 according to the DSC method. For example, the HDMI repeater 100 may perform DSC encoding on the HDMI signal received through the four lanes at 10 Gbps per lane to transform the HDMI signal into an HDMI signal for three lanes at 6 Gbps per lane.

The HDMI repeater 100 may transmit the encoded HDMI signal to the HDMI sink device 200 through Lane 0, Lane 1, and Lane 3.

The HDMI sink device 200 according to an embodiment may receive the HDMI signal through the changed signal lanes in operation S670.

The HDMI sink device 200 may determine whether the received HDMI signal is encoded in operation S680. When the received HDMI signal is an encoded signal S680 (Yes), the HDMI sink device 200 may perform decoding on the signal. For example, the HDMI sink device 200 may decode the HDMI signal received from the HDMI repeater 100 according to the DSC method in operation S685. When the received HDMI signal is not an encoded signal (e.g. is a decoded signal) S680 (No), the HDMI sink device 200 may display an image corresponding to video data in the signal in operation S690.

The HDMI sink device 200 may process the decoded signal and display an image corresponding to video data in the processed signal in operation S690.

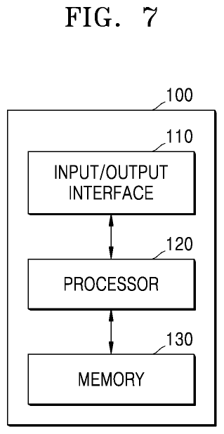

FIG. 7 is a block diagram of components of an HDMI repeater, according to an embodiment.

Referring to FIG. 7, the HDMI repeater 100 according to an embodiment may include an input/output interface 110, a processor 120, and memory 130.

The input/output interface 110 according to an embodiment may transmit and receive data or a signal to and from an external device (for example, a source device or an HDMI sink device) or a server. For example, the input/output interface 110 may include at least one port for connection with the external device through a wired cable to communicate with the external device in a wired manner. For example, the input/output interface 110 may include at least one of an HDMI port, a mobile high-defining link (MHL) port, a universal serial bus (USB) port, a display port (DP), a Thunderbolt port, a video graphics array (VGA) port, an RGB port, d-subminiature (D-SUB), a digital visual interface (DVI), a component jack, or a PC port. The input/output interface 110 may perform communication with the external device connected in the wired manner through the at least one port.

For example, the input/output interface 110 may be connected to the source device 10 and the HDMI sink device 200. The input/output interface 110 may receive an HDMI signal from the source device 10 and output the HDMI signal to the HDMI sink device 200.

The processor 120 according to an embodiment may control general operation of the HDMI repeater 100 and signal flows between internal components of the HDMI repeater 100, and may process data. In detail, the processor 120 may control a process of transmitting the HDMI signal received from the source device 10 to the HDMI sink device 200.

The processor 120 may execute one or more programs stored in the memory 130. The memory 130 according to an embodiment may store various data, programs, or applications for driving and controlling the HDMI repeater 100.

Also, the programs stored in the memory 130 may include one or more instructions. The programs (the one or more instructions) or the applications stored in the memory 130 may be executed by the processor 120.

The processor 120 may execute one or more programs stored in the memory 130 to control the input/output interface 110 to transmit the HDMI signal received from the source device 10 to the HDMI sink device 200.

The processor 120 may execute the one or more programs stored in the memory 130 to change a lane for transmitting the HDMI signal in response to a corresponding command, when a lane change command is received from the HDMI sink device 200. For example, when the processor 120 receives a command to change Lane 2 from the HDMI sink device 200 while the processor 120 transmits the HDMI signal to the HDMI sink device 200 through Lane 0, Lane 1, and Lane 2, the processor 120 may change the transmission lane from Lane 2 to Lane 3. The processor 120 may control the input/output interface 110 to transmit the HDMI signal to the HDMI sink device 200 through Lane 0, Lane 1, and Lane 3.

The processor 120 may execute the one or more programs stored in the memory 130 to compare the number of signal lanes through which the HDMI signal is received from the source device 10 with the number of signal lanes through which the HDMI signal is to be transmitted to the HDMI sink device 200. When the number of signal lanes through which the HDMI signal is to be transmitted to the HDMI sink device 200 is greater than or equal to the number of signal lanes through which the HDMI signal is received, the processor 120 may change the lane for transmitting the HDMI signal. The processor 120 may control the input/output interface 110 to transmit the HDMI signal to the HDMI sink device 200 through the changed lane.

However, when the number of signal lanes through which the HDMI signal is to be transmitted to the HDMI sink device 200 is less than the number of signal lanes through which the HDMI signal is received, the processor 120 may encode the HDMI signal received from the source device 10. For example, the processor 120 may perform encoding on the HDMI signal received from the source device 10 according to a DSC method. The processor 120 may transmit the encoded HDMI signal to the HDMI sink device 200 through the changed transmission lane.

For example, when the number of signal lanes through which the HDMI signal is to be transmitted to the HDMI sink device 200 is 3 and the number of signal lanes through which the HDMI signal is received is 4, the processor 120 may encode the HDMI signal received from the source device 10 according to the DSM method. The processor 120 may perform DSC encoding on the HDMI signal received through the four signal lanes at 10 Gbps per lane, to transform the HDMI signal into an HDMI signal for the three signal lanes to be transmitted at 6 Gbps per lane. The processor 120 may control the input/output interface 110 to transmit the encoded HDMI signal to the HDMI sink device 200 through the three signal lanes.

FIG. 7 shows the block diagram of the HDMI repeater 100 according to an embodiment. The components of the block diagram may be integrated, added, or omitted according to the specification of the actually realized HDMI repeater 100. That is, two or more components may be integrated into one component, or one component may be divided into two or more components, according to necessity. Also, a function executed in each block is explained to describe the embodiments, and its specific operation or device does not limit the scope of the claims of the present disclosure.

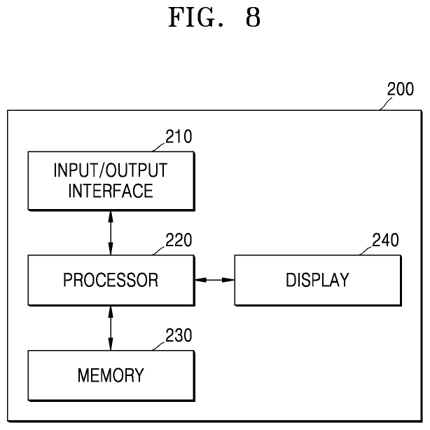

FIG. 8 is a block diagram of components of an HDMI sink device, according to an embodiment.

Referring to FIG. 8, the HDMI sink device 200 according to an embodiment may include an input/output interface 210, a processor 220, memory 230, and a display 240.

The input/output interface 210 according to an embodiment may transmit and receive data or a signal to and from an external device (for example, an HDMI repeater) or a server. For example, the input/output interface 210 may include at least one port for connection with the external device through a wired cable to communicate with the external device in a wired manner. For example, the input/output interface 210 may include at least one of an HDMI port, an MHL port, a USB port, a DP, a Thunderbolt port, a VGA port, an RGB port, D-SUB, a DVI, a component jack, or a PC port. The input/output interface 210 may perform communication with the external device connected in the wired manner through the at least one port.

For example, the HDMI sink device 200 may be connected to the HDMI repeater 100 through the input/output interface 210. The input/output interface 210 may receive an HDMI signal from the HDMI repeater 100. Also, the HDMI sink device 200 may transmit a lane change command to the HDMI repeater 100 through the input/output interface 210.

The processor 220 according to an embodiment may control general operation of the HDMI sink device 200 and signal flows between internal components of the HDMI sink device 200, and may process data.

The processor 220 may include a single core, a dual core, a triple core, a quad core, and its multiple core. Also, the processor 220 may include a plurality of processors. For example, the processor 220 may be realized as a main processor (not shown) and a sub-processor (not shown).

Also, the processor 220 may include at least one of a central processing unit (CPU), a graphics processing unit (GPU), and a video processing unit (VPU). Alternatively, according to an embodiment, the processor 220 may be realized as a system on chip (SoC) in which one or more of a CPU, a GPU, and a VPU are integrated. Alternatively, the processor 220 may further include a neural processing unit (NPU).

The memory 230 according to an embodiment may store various data, programs, or applications for driving and controlling the HDMI sink device 200.

Also, the programs stored in the memory 230 may include one or more instructions. The programs (the one or more instructions) or the applications stored in the memory 230 may be executed by the processor 220.

The processor 220 according to an embodiment may execute the one or more instructions stored in the memory 230 to receive the HDMI signal from the HDMI repeater 100 and detect an abnormality of signal lanes through which the HDMI signal is received.

The processor 220 may obtain information indicating a channel state, information about an error occurrence, etc. corresponding to each of the lanes through which the HDMI signal is received. The HDMI sink device 200 may include a register storing information corresponding to each signal lane, and the register may include an SCDC register. However, it is not limited thereto.

For example, the register may include the information indicating the channel state corresponding to each lane. Here, the information indicating the channel state may include information indicating whether or not a content signal (a video or audio signal) is normally transmitted and received through a corresponding channel (lane). For example, the channel state information may include a value of Chx_Lnx_Locked, wherein, when the value of Chx_Lnx_locked is “1,” it is indicated that the content signal is normally transmitted and received through a corresponding channel, and when the value of Chx_Lnx_locked is “0,” it is indicated that the content signal is not normally transmitted and received through the corresponding channel. However, it is not limited thereto.

When the value of Chx_Lnx_Locked of the register is “0,” the processor 220 may determine that there is an abnormality in the corresponding channel (lane).

Also, the register may detect an error occurrence corresponding to each signal lane. For example, the register may detect an occurrence of a CED error, wherein the CED error may include an error generated when there is a problem during a process of transmitting or processing control data packets included in the HDMI signal received through a corresponding channel (lane). When the occurrence of the CED error is detected in the register, the processor 220 may determine that there is an abnormality in the corresponding channel (lane).

Alternatively, the register may include an RSCC value. The register may detect an error of a Reed-Solomon parity value included in the HDMI signal, and whenever the error is detected, may increase the RSCC value. When the RSCC value of the register is a preset value or higher, the processor 220 may determine that there is an abnormality in the corresponding channel (lane).

Methods used by the processor 220 to detect whether or not there is an abnormality in the lanes through which the HDMI signal is received are not limited to the examples described above, and various methods may be used to determine whether or not there is an abnormality in the lanes and identify the lane having an abnormality.

The processor 220 according to an embodiment may execute the one or more instructions stored in the memory 230 to control the input/output interface 210 to transmit a lane change command to the HDMI repeater 100.

When the lane having an abnormality is identified, the processor 220 may transmit the lane change command requesting a change of the lane having an abnormality to the HDMI repeater 100.

The processor 220 may transmit the lane change command through other communication methods than the HDMI communication. For example, the processor 220 may control the input/output interface 210 to transmit the lane change command through an I2C communication method. However, it is not limited thereto.

The processor 220 may receive the HDMI signal through a changed lane.

When the received HDMI signal is an encoded signal, the processor 220 may decode the signal. For example, the processor 220 may decode the HDMI signal received from the HDMI repeater 100, according to a DSC method.

The display 240 according to an embodiment may generate a driving signal by converting an image signal, a data signal, an on-screen display (OSD) signal, a control signal, etc. processed by the processor 220. The display 240 may be realized as a plasma display (PDP), a liquid crystal display (LCD), an organic light-emitting display (OLED), a flexible display, etc. or may also be realized as a three-dimensional (3D) display. Also, the display 240 may be formed as a touch screen and may be used as an input device as well as an output device.

The display 240 according to an embodiment may display an image corresponding to the HDMI signal received from the HDMI repeater 100. For example, the processor 220 may process the received HDMI signal and may control the display 240 to display an image corresponding to video data in the processed signal.

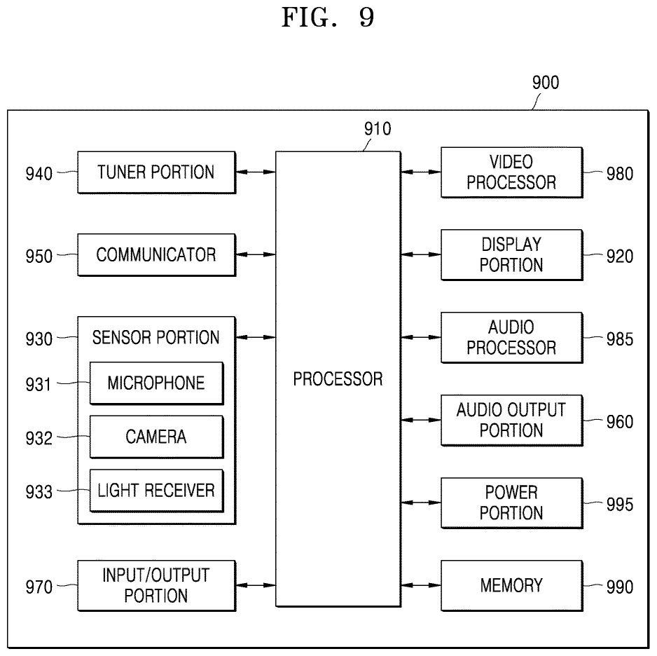

FIG. 9 is a block diagram of components of an HDMI sink device, according to an embodiment.

An HDMI sink device 900 of FIG. 9 may correspond to an embodiment of the HDMI sink device 200 described with reference to FIGS. 1 to 8.

Referring to FIG. 9, the HDMI sink device 900 according to an embodiment may include a tuner portion 940, a processor 910, a display portion 920, a communicator 950, a sensor portion 930, an input/output portion 970, a video processor 980, an audio processor 985, an audio output portion 960, memory 990, and a power portion 995.

The input/output portion 970 of FIG. 9 may correspond to the input/output interface 210 of FIG. 8, the processor 910 of FIG. 9 may correspond to the processor 220 of FIG. 8, the memory 990 of FIG. 9 may correspond to the memory 230 of FIG. 8, and the display portion 920 of FIG. 9 may correspond to the display 240 of FIG. 8. Thus, the same aspects as described above are omitted.

The tuner portion 940 according to an embodiment may tune and select only a frequency of a channel to be received by the HDMI sink device 900 from among many electro-wave components, through amplification, mixing, resonance, etc. with respect to broadcasting signals, etc. received in a wired or wireless manner. The broadcasting signal may include audio data, video data, and auxiliary data (for example, an electronic program guide (EPG)).

The tuner portion 940 may receive the broadcasting signals from various sources, such as ground wave broadcasting, cable broadcasting, satellite broadcasting, Internet broadcasting, etc. The tuner portion 940 may receive the broadcasting signals from sources, such as analog broadcasting or digital broadcasting.

The communicator 950 according to an embodiment may include a WiFi module, a Bluetooth module, an infrared communication module, a wireless communication module, a local area network (LAN) module, an Ethernet module, etc. Here, each communication module may be realized as at least one hardware chip.

The WiFi module and the Bluetooth module may perform communication in a WiFi manner and a Bluetooth manner, respectively. When the WiFi module or the Bluetooth module is used, first, various connection information such as a service set identifier (SSID) and a session key is transmitted and communication is connected by using this information, and then, various information may be transmitted and received. The wireless communication module may include at least one communication chip performing communication according to various wireless communication standards, such as Zigbee, the 3G, the 3G partnership project (3GPP), long term evolution (LTE), LTE advanced (LTE-A), the 4G, the 5G, etc.

The communicator 950 may receive a control signal or a control command from an external control device. For example, the communicator 950 may include an infrared (IR) module which may transmit and receive a signal to and from an external control signal according to the IR communication standard. In detail, the communicator 950 may receive a control signal or a control command corresponding to a user input (for example, a key or button input of a control device) from the control device.

The sensor portion 930 according to an embodiment may sense a voice of a user, an image of the user, or an interaction of the user and may include a microphone 931, a camera 932, and a light receiver 933.

The microphone 931 may receive an uttered voice of the user. The microphone 931 may output the received voice to the processor 910 by converting the received voice into an electrical signal. The voice of the user may include, for example, a voice corresponding to a menu or a function of the HDMI sink device 900.

The camera 932 may receive an image (for example, consecutive frames) corresponding to a motion of a user including a gesture within a camera recognition range. The processor 910 may select a menu displayed on the HDMI sink device 900 by using a result of recognizing the received motion or may perform a control operation corresponding to the result of recognizing the receiving motion.

The light receiver 933 may receive a light signal (including a control signal) from an external controller through an optical window (not shown) of a bezel of the display portion 920. The light receiver 933 may receive, from the controller, the light signal corresponding to a user input (for example, a touch input, a press input, a touch gesture, a voice, or a motion). A control signal may be extracted from the received light signal according to control by the processor 910.

The processor 910 may control general operation of the HDMI sink device 900 and signal flows between internal components of the HDMI sink device 900, and may process data. When there is a user input or a condition predetermined and stored is met, the processor 910 may execute an operation system (OS) or various applications stored in the memory 990.

The processor 910 may include random-access memory (RAM) used as a storage for storing signals or data input from the outside of the HDMI sink device 900 or as a storage corresponding to various operations performed by the HDMI sink device 900, read-only memory (ROM) storing control programs for controlling operations by the HDMI sink device 900, and a processor.

The video processor 980 may process video data received by the HDMI sink device 900. The video processor 980 may perform various image processing operations on the video data, such as decoding, scaling, noise filtering, frame rate conversion, resolution conversion, etc.

The audio processor 985 may process the audio data. The audio processor 985 may perform various processing operations on the audio data, such as decoding, amplification, noise filtering, etc. The audio processor 985 may include a plurality of audio processing modules for processing audio corresponding to a plurality of pieces of content.

The audio output portion 960 may output audio included in the broadcasting signal received through the tuner portion 940 according to control by the processor 910. The audio output portion 960 may output audio (for example, a voice, sound, etc.) that is input through the communicator 950 or the input/output portion 970. Also, the audio output portion 960 may output audio stored in the memory 990 according to control by the processor 910. The audio output portion 960 may include at least one of a speaker, a headphone output terminal, or a Sony/Philips digital interface (S/PDIF) output terminal.

The power portion 995 may supply power that is input from an external power source to the components in the HDMI sink device 900 according to control by the processor 910. Also, the power portion 996 may supply power, which is output from one battery or two or more batteries (not shown) included in the HDMI sink device 900, to the internal components according to control by the processor 910.

The memory 990 may store various data, programs, or applications for driving and controlling the HDMI sink device 900 according to control by the processor 910. The memory 990 may include a broadcasting receiving module, a channel control module, a volume control module, a communication control module, a voice recognition module, a motion recognition module, a light receiving module, a display control module, an audio control module, an external input control module, a power control module, a power control module of an external device, which is connected wirelessly (for example, through Bluetooth), a voice database (DB), or a motion DB that is not shown. The modules and the DBs of the memory 990 that are not shown may be realized as software to perform, in the HDMI sink device 900, a broadcasting reception control function, a channel control function, a volume control function, a communication control function, a voice recognition function, a motion recognition function, a light reception control function, a display control function, an audio control function, an external input control function, a power control function, or a power control function of the external device connected wirelessly (for example, through Bluetooth). The processor 910 may perform each of these functions by using the software stored in the memory 990.

In addition, FIGS. 8 and 9 show the block diagrams of the HDMI sink devices 200 and 900, respectively, according to an embodiment. The components of the block diagrams may be integrated, added, or omitted according to the specifications of the actually realized HDMI sink devices 200 and 900. That is, two or more components may be integrated into one component, or one component may be divided into two or more components, according to necessity. Also, a function executed in each block is explained to describe the embodiments, and its specific operation or device does not limit the scope of the claims of the present disclosure.

A first electronic device according to an embodiment may include an input/output interface configured to receive an HDMI signal from a source device and transmit the HDMI signal to a second electronic device.

The first electronic device according to an embodiment may include memory storing one or more instructions and at least one processor configured to execute the one or more instructions.

The at least one processor may execute the one or more instructions to control the input/output interface to transmit the HDMI signal received from the source device to the second electronic device through a plurality of signal lanes.

The at least one processor may execute the one or more instructions to control the input/output interface to transmit the HDMI signal to the second electronic device through the changed signal lane, based on receiving a lane change command from the second electronic device.

The at least one processor may execute the one or more instructions to perform encoding on the HDMI signal, based on the number of first signal lanes through which the HDMI signal is received from the source device and the number of second signal lanes through which the HDMI signal is transmitted to the second electronic device.

The at least one processor may execute the one or more instructions to perform DSC encoding on the HDMI signal, based on the number of first signal lanes being greater than the number of second signal lanes.

The at least one processor may execute the one or more instructions to control the input/output interface to transmit the HDMI signal on which the DSC encoding is performed to the second electronic device.

The at least one processor may execute the one or more instructions to receive the lane change command through a communication method different from an HDMI communication method, or protocol.

The different communication method may include an I2C communication method, or protocol.

The second electronic device according to an embodiment may include an input/output interface configured to receive the HDMI signal from the first electronic device.

The second electronic device according to an embodiment may include a display, memory storing one or more instructions, and at least one processor configured to execute the one or more instructions.

The at least one processor may execute the one or more instructions to identify an abnormalsignal lane \from among the plurality of signal lanes through which the HDMI signal is received.

The at least one processor may execute the one or more instructions to control the input/output interface to transmit a lane change command requesting a change of the abnormal signal lane to the first electronic device.

The at least one processor may execute the one or more instructions to control the input/output interface to receive the HDMI signal through a changed signal lane.

The at least one processor may execute the one or more instructions to control the display to display content corresponding to the received HDMI signal.

The at least one processor may execute the one or more instructions to identify the abnormal signal lane, based on at least one of information indicating a channel state and information indicating an error occurrence corresponding to each of the plurality of signal lanes through which the HDMI signal is received.

The information indicating the channel state may include information indicating locked lock state corresponding to the abnormal signal lane.

The information indicating the error occurrence may include at least one of CED information and RSCC information corresponding to the signal lane.

The at least one processor may execute the one or more instructions to control, based on identifying that a first signal lane from among the plurality of signal lanes has an abnormality, the input/output interface to transmit, to the first electronic device, the lane change command to instruct a change of a lane for transmitting the HDMI signal from the first signal lane to a second signal lane.

The at least one processor may execute the one or more instructions to control the input/output interface to transmit the lane change command to the first electronic device through a communication method, or protocol, different from the HDMI communication method, or protocol.

The different communication method may include an I2C communication method, or protocol.

The at least one processor may execute the one or more instructions to perform DSC decoding on the received HDMI signal, based on the received HDMI signal including a signal on which DSC encoding is performed.

An operating method of the first electronic device according to an embodiment may include receiving an HDMI signal from the source device.

The operating method of the first electronic device according to an embodiment may include transmitting an HDMI signal received from the source device to the second electronic device through a plurality of signal lanes.

The operating method of the first electronic device according to an embodiment may include transmitting the HDMI signal to the second electronic device through a changed signal lane, based on receiving a lane change command from the second electronic device.

The operating method of the first electronic device according to an embodiment may further include performing encoding on the HDMI signal, based on the number of first signal lanes through which the HDMI signal is received from the source device and the number of second signal lanes through which the HDMI signal is transmitted to the second electronic device.

The performing of the encoding on the HDMI signal may include performing DSC encoding on the HDMI signal, based on the number of first signal lanes being greater than the number of second signal lanes.

The transmitting of the HDMI signal to the second electronic device through the changed signal lane may include transmitting the HDMI signal on which the DSC encoding is performed to the second electronic device.

An operating method of the second electronic device according to an embodiment may include receiving the HDMI signal from the first electronic device.

The operating method of the second electronic device according to an embodiment may include identifying an abnormal signal lane from among a plurality of signal lanes through which the HDMI signal is received.

The operating method of the second electronic device according to an embodiment may include transmitting a lane change command requesting a change of the abnormal signal lane to the first electronic device.

The operating method of the second electronic device according to an embodiment may include receiving the HDMI signal through a changed signal lane.

The operating method of the second electronic device according to an embodiment may include displaying content corresponding to the received HDMI signal.

The identifying of the abnormal signal lane through which the HDMI signal is received may include identifying the signal lane having an abnormality, based on at least one of information indicating a channel state and information indicating an error occurrence corresponding to each of the plurality of signal lanes through which the HDMI signal is received.

The information indicating the channel state may include information indicating a lock state corresponding to the abnormal signal.

The information indicating the error occurrence may include at least one of CED information and RSCC information corresponding to the abnormal signal lane.

The operating method of the second electronic device according to an embodiment may further include performing DSC decoding on the received HDMI signal, based on the received HDMI signal including a signal on which DSC encoding is performed.

The first electronic device according to an embodiment may normally transmit the HDMI signal to the second electronic device by changing the transmission lane, when an abnormality occurs in some of the plurality of signal lanes through which the HDMI signal is transmitted to the second electronic device.

The second electronic device according to an embodiment may normally receive the HDMI signal from the first electronic device by detecting an occurrence of an abnormality in some of the plurality of signal lanes through which the HDMI signal is received from the first electronic device and transmitting the lane change command to the first electronic device.

Accordingly, in an electronic device, a no signal phenomenon or a black screen phenomenon due to an HDMI transmission lane may be reduced, and a use environment for a user may be improved.

The operating method of the first electronic device and the operating method of the second electronic device according to an embodiment may be realized as program commands which may be executed by various computer devices, and may be recorded on a computer-readable medium. The computer-readable medium may separately include each of a program command, a data file, a data structure, etc. or may include a combination thereof. The program command recorded on the medium may be specially designed and configured for the present disclosure or may be known to and usable by one of ordinary skill in the field of computer software. Examples of the computer-readable recording medium include magnetic media, such as hard discs, floppy discs, or magnetic tapes, optical media, such as compact disc (CD)-ROMs or DVDs, magneto-optical media, such as floptical discs, and hardware devices that are specially configured to store and execute program commands, such as ROMs, RAMs, or flash memories. Examples of the program commands include a high-level language code executable by a computer by using an interpreter, etc., as well as a machine language code, such as the one made by a complier.

Also, the operating method of the first electronic device and the operating method of the second electronic device according to an embodiment may be provided by being included in a computer program product. The computer program product may be transacted between a seller and a purchaser as a product.

The computer program product may include a software (S/W) program or a computer-readable storage medium storing an S/W program. For example, the computer program product may include a product in the form of an S/W program (for example, a downloadable application) that is electronically distributed through a manufacturer of the electronic device or an electronic market (for example, a Google play store or an App store). For electronic distribution, at least part of the S/W program may be stored in a storage medium or temporarily generated. In this case, the storage medium may include a server of a manufacturer, a server of an electronic market, or a storage medium of a relaying server temporarily storing the S/W program.

In a system including a server and a client device, the computer program product may include a storage medium of the server or a storage medium of the client device. Alternatively, when there is a third device (for example, a smartphone) connected to the server or the client device for communication, the computer program product may include a storage medium of the third device. Alternatively, the computer program product may directly include an S/W program transmitted from the server to the client device or the third device or transmitted from the third device to the client device.

In this case, any one of the server, the client device, and the third device may perform the method according to the embodiments by executing the computer program product. Alternatively, at least two of the server, the client device, and the third device may perform the method according to the embodiments by executing the computer program product in a distributed fashion.

For example, the server (for example, a cloud server or an artificial intelligence (AI) server) may execute a computer program product stored in the server to control the client device connected to the server for communication to perform the method according to the embodiments.

Although embodiments are described in detail above, the scope of the claims of the present disclosure is not limited thereto, and various modifications and alterations by one of ordinary skill in the art using basic concept of the present disclosure defined by the following claims are also included in the scope of the claims of the present disclosure.

What is claimed:

1. A first electronic device comprising:
a transceiver configured to transmit a high definition multi-media (HDMI) signal to a second electronic device;
memory storing one or more instructions; and
at least one processor configured to execute the one or more instructions,
wherein the at least one processor is configured to execute the one or more instructions to:
control the transceiver to transmit the HDMI signal to the second electronic device through a plurality of signal lanes; and
control the transceiver to transmit the HDMI signal to the second electronic device through a changed signal lane, based on receiving a lane change command from the second electronic device.

2. The first electronic device of claim 1, wherein the at least one processor is configured to execute the one or more instructions to:
perform encoding on the HDMI signal, based on a number of first signal lanes through which the HDMI signal is received from a source device and a number of second signal lanes through which the HDMI signal is transmitted to the second electronic device.

3. The first electronic device of claim 2, wherein the at least one processor is configured to execute the one or more instructions to:
perform display stream compression (DSC) encoding on the HDMI signal, based on the number of first signal lanes being greater than the number of second signal lanes; and
control the transceiver to transmit the HDMI signal on which the DSC encoding is performed to the second electronic device.

4. The first electronic device of claim 1, wherein the at least one processor is configured to execute the one or more instructions to:
receive the lane change command through a communication protocol different from an HDMI communication protocol.

5. The first electronic device of claim 4, wherein the communication protocol comprises an inter-integrated circuit (I2C) communication protocol.

6. A second electronic device comprising:
a transceiver configured to receive a high-definition multi-media interface (HDMI) signal from a first electronic device;
a display;
memory storing one or more instructions; and
at least one processor configured to execute the one or more instructions,
wherein the at least one processor is configured to execute the one or more instructions to:
identify an abnormal signal lane from among a plurality of signal lanes through which the HDMI signal travels;
control the transceiver to transmit, to the first electronic device, a lane change command requesting a change of the abnormal signal lane;
control the transceiver to receive the HDMI signal through a changed signal lane; and
control the display to display content corresponding to the HDMI signal.

7. The second electronic device of claim 6, wherein the at least one processor is configured to execute the one or more instructions to:
identify the abnormal signal lane, based on at least one of information indicating a channel state and information indicating an error occurrence corresponding to each of the plurality of signal lanes through which the HDMI signal is received.

8. The second electronic device of claim 7, wherein the information indicating the channel state comprises information indicating a lock state corresponding to the abnormal signal lane, and
the information indicating the error occurrence comprises at least one of control error detection (CED) information corresponding to the abnormal signal lane and Reed-Solomon corrections counter (RSCC) information corresponding to the abnormal signal lane.

9. The second electronic device of claim 6, wherein the at least one processor is configured to execute the one or more instructions to:
control, based on identifying that a first signal lane from among the plurality of signal lanes is abnormal, the transceiver to transmit to the first electronic device, the lane change command instructing a change of a lane for transmitting the HDMI signal from the first signal lane to a second signal lane.

10. The second electronic device of claim 6, wherein the at least one processor is configured to execute the one or more instructions to:
control the transceiver to transmit the lane change command to the first electronic device through a communication protocol different from an HDMI communication protocol.

11. The second electronic device of claim 10, wherein the communication protocol comprises an inter-integrated circuit (I2C) communication protocol.

12. The second electronic device of claim 6, wherein the at least one processor is configured to:
execute the one or more instructions to perform display stream compression (DSC) decoding on the HDMI signal, based on the HDMI signal comprising a signal on which DSC encoding is performed.

13. An operating method of a first electronic device, the operating method comprising:
transmitting a HDMI signal to a second electronic device through a plurality of signal lanes; and
transmitting the HDMI signal to the second electronic device through a changed signal lane, based on receiving a lane change command from the second electronic device.

14. An operating method of a second electronic device, the operating method comprising:
receiving a high-definition multi-media interface (HDMI) signal from a first electronic device;
identifying an abnormal signal lane from among a plurality of signal lanes through which the HDMI signal travels;
transmitting a lane change command requesting a change of the abnormal signal lane to the first electronic device;
receiving the HDMI signal through a changed signal lane; and
displaying an image corresponding to the HDMI signal.

15. A non-transitory computer-readable recording medium having stored thereon a program for executing the method of claim 13.

16. A non-transitory computer-readable recording medium having stored thereon a program for executing the method of claim 14.
